(19) United States
(12) Patent Application Publication
(10) Pub. No.: US 2024/0396028 A1
(43) Pub. Date: Nov. 28, 2024

(54) SURFACE CHARACTERIZATION & OPTIMIZATION OF POROUS ZINC ANODES TO IMPROVE CYCLE STABILITY BY MITIGATING DENDRITIC GROWTH

(71) Applicant: UNM RAINFOREST INNOVATIONS, Albuquerque, NM (US)

(72) Inventors: Shuya WEI, Albuquerque, NM (US); Matthew POWELL, Albuquerque, NM (US)

(73) Assignee: UNM RAINFOREST INNOVATIONS, Albuquerque, NM (US)

(21) Appl. No.: 18/674,145

(22) Filed: May 24, 2024

Related U.S. Application Data
(60) Provisional application No. 63/504,026, filed on May 24, 2023.

(51) Int. Cl. H01M 4/38; H01M 4/02; H01M 4/04; H01M 10/38; H01M 50/153; H01M 50/477

(52) U.S. Cl. CPC H01M 4/38; H01M 4/043; H01M 10/38; H01M 50/153; H01M 50/477; H01M 2004/027; H01M 2300/0011

(57) ABSTRACT

A battery and a method of making a battery is disclosed. The battery includes an anode, the anode comprising a metal having a porous 3D structure, and a cathode.

### CROSS-REFERENCE TO RELATED APPLICATIONS

This application claims benefit to U.S. Provisional Patent Application No. 63/504,026 filed on May 24, 2023, the contents of which are hereby incorporated by reference in its entirety.

### GOVERNMENT SUPPORT

This invention was made with government support under grant no. NSF 2119688 awarded by the National Science Foundation. The government has certain rights in the invention.

### FIELD

The application relates to surface characterization and optimization of porous zinc anodes to improve cycle stability by mitigating dendritic growth.

### BACKGROUND

The current energy storage market has been dominated by Lithium-ion batteries (LiBs) during the twenty-first century. However, LiBs are reaching their theoretical limit, so researchers are now looking into alternative battery chemistries that have higher theoretical energy densities and larger capacities. One potential solution is to fabricate metal anode batteries. Metal anodes provide a much larger theoretical capacity than metal ion batteries, however, several fundamental challenges still need to be overcome before metal anode batteries are able to compete and replace LiBs in the global energy storage market as well as being used for grid storage application. Additionally, lithium-based batteries require lithium and other expensive rare earth metals such as cobalt that require extensive extraction techniques. Furthermore, lithium is dangerous to work with and can react with air, so an inert atmosphere is required to process and assembly lithium-based batteries. One potential alternative to LiBs is zinc-based batteries. Zinc is an abundant and inexpensive metal that is found all around the globe. It is safe to work with, nonreactive in air, and can work in aqueous conditions. However, like all other metal-anode batteries, zinc anodes are prone to the same failure mechanisms. Metal anodes in aqueous electrolytes typically fail from one of the following mechanisms: (1) passivation layer formation; (2) dendrite formation; (3) hydrogen evolution; and (4) other undesired side reaction. These failure mechanisms can be visualized in FIG. 1A.

Researchers have tried a variety of potential solutions to improve the plating mechanics of the zinc metal anode. They found that the cycle life of the cell can be improved through electrolyte optimization, the addition of alloys to the metal, metal coating, and using a porous 3-D structure in place of the standard 2D planar structure. It has been found that using a porous structure as the anode in place of planar metal can suppress dendrite growth by increasing the effective diffusion limiting current, weakening the local electric field strength. It allows for even plating cycle and prevents dendritic growth on the anode.

### SUMMARY

Zinc-based batteries are a scalable and safe alternative to Lithium-ion batteries due to the nature of abundance, low cost and easy to process. In accordance with examples of the present disclosure, synthesized porous zinc electrodes (PZEs) via a gel-binder method are disclosed that can stably charge and discharge for over 700 h at 1 mA cm⁻² before showing signs of failure. A comparison between PZEs synthesized from small (60 nm), intermediate (10 μm). and large (150 μm) zinc particles is provided to determine which surface features are best suited to mitigate dendritic growth and to improve electrolyte stability. The zinc deposit on the large PZE shows a stable and flat morphology. which does not form the hexagonal close-packed (HCP) crystal structure that is typically seen on planar zinc anodes. The intermediate PZE has an increased affinity to depo. it onto the glass microfiber separator leading to a decrease of active material on the anode that causes instability during galvanostatic cycling. Both planar zinc and small PZE show HCP deposits that are normal to the surface, which result in very poor electrochemical performance. As the particle size increases, the deposits transition from HCP crystals to flat amorphous metal deposits, increasing cyclic stability.

According to examples of the present disclosure, a battery is disclosed that comprises an anode, the anode comprising a metal having a porous 3D structure and a cathode. In some examples, the metal is zinc and/or the metal is coated on the surface of the anode.

According to examples of the present disclosure, a method of fabricating a zinc anode is disclosed. The method comprises combining 83 wt % zinc, 9.8 wt % zinc oxide, 2.2 wt % sodium dodecylbenzenesulfonate (SDBS), and 5 wt % polytetrafluoroethylene (PTFE); adding sufficient amounts of isopropyl alcohol (IPA) for about one hour to produce a combined puddy product; pressing the combined puddy product until flat and around I mm in thickness; cut the combined puddy product that is pressed into circles with W′ or ⅝″ diameters to produce cut Porous Zinc electrodes (PZEs); during the cut PZE in a vacuum oven to be dried over night at a temperature of about 60° C.; at a pressure of 650 mmHg to produce dried PZE; and assembling the dried PZE into coin cells. In some examples, the method further comprising prior to assembly, the PZE were washed in acetone and de-ionized (DI) water.

According to examples of the present disclosure, a method of assembling a battery. The method comprises placing a first zinc electrode into a bottom cap and placing a separator on top of the first zinc electrode; adding 100 μL of 2M ZnS04 with 5 wt % polyethylene glycol 300 (PEG300) to the separator; placing a second zinc electrode on top of the separator, wherein the second zinc electrode is smaller than the first zinc electrode; placing a spacer on top of the second zinc electrode; placing a wave spring on top of the spacer; and placing a top cap on top of the wave spring.

### BRIEF DESCRIPTION OF THE FIGURES

FIG. 1A and FIG. 1B show schematic diagram of plating patterns on a planar zinc and a porous zinc electrode, as well as failure mechanisms that plague metal anodes, according to examples of the present disclosure, where FIG. 1A shows a planar zinc and several failure mechanisms including: (1) an insulating layer of zinc oxide that passivates on the surface of the anode. (2) hydrogen evolution producing hydrogen gas and degrading the electrolyte and (3) dendrite formation, uneven plating causing tree like branches to form over repeated cycles until the separator is pieced and a bridge between the electrodes is formed causing the cell to short and FIG. 1B shows a dendrite plating structure on a porous zinc anode according to examples of the present disclosure.

FIG. 2A, FIG. 2B, FIG. 2C, FIG. 2D, and FIG. 2E show SEM images or the pristine planar and porous zinc anodes made from different zinc particle sizes according to examples of the present disclosure, where planar zinc is shown in FIG. 2A, 60 nm is shown in FIG. 2B, 10 μm is shown in FIG. 2C, 150 μm is shown in FIG. 2D, and optical visualization of zinc anodes, from the left planer zinc, 60 nm, 10 μm, and 150 μm are shown in FIG. 2E.

FIG. 3A, FIG. 3B, FIG. 3C, and FIG. 3D show electrochemical characterization of the PZEs fabricated from different starting particle sizes according to examples of the present disclosure, where FIG. 3A shows galvanostatic cycling of symmetric coin cells of various starting particle sizes and all tests occur under a current density of 1 mA cm⁻² and use an electrolyte of 2 M ZnSO₄+5 wt % PEG300, FIG. 3B shows a EIS Nyquist plot comparing the resistance of different porous anodes to planar zinc and the insect shows a zoomed in scale of FIG. 3B, FIG. 3C shows LVS curves comparing 150 μm PZE, 10 μm PZE and planar zinc at a scan rate of 1 mV s⁻¹, and FIG. 3D shows depth or di charge testing comparing 150 μm PZE, 10 μm PZE and planar zinc.

FIG. 4A, FIG. 4B, FIG. 4C, and FIG. 4D show SEM images of zinc electrodes made from different particle sizes, where symmetric coin cells in an electrolyte of 2 M ZnS0₄+5 wt % PEG300 are tested under a constant current of 1 mAcm⁻² until failure according to examples of the present disclosure, where a planar zinc is shown in FIG. 4A, 60 nm is shown in FIG. 4B, 10 μm is shown in FIG. 4C, and 150 μm is shown in FIG. 4D.

FIG. 5A, FIG. 5B, FIG. 5C, FIG. 5D, and FIG. 5E show intermediate and large PZE from various cycles to view surface changes over time according to examples of the present disclosure, where the top row is intermediate PZE at 10 cycle shown in FIG. 5A, 20 cycles shown in FIG. 5B, 100 cycles shown in FIG. 5C and the bottom row is large PZE at 10 cycle shown in FIG. 5D, 20 cycles shown in FIG. 5E, and 100 cycles shown in FIG. 5F.

FIG. 6 shows XRD analysis of pristine and cycled anodes according to examples of the present disclosure, where peaks for zinc (98-000-0482) is shown by A, peaks for zinc oxide (98-000-0483) is shown by B, and peaks for PTFE (00-047-22 17) is shown by C.

FIG. 7A and FIG. 7B show a coin cell configuration of Zn∥Zn cells and Zn vs. stainless steel, respectively, according to examples of the present disclosure.

FIG. 8A and FIG. 8B show BET analysis results according to examples of the present disclosure.

FIG. 9A, FIG. 9B, and FIG. 9C shows an EDS analysis of PZE, according to examples of the present disclosure, where FIG. 9A where FIG. 9A shows EDS analysis for pristine 60 nm, FIG. 9B shows EDS analysis for pristine 10 μm, and FIG. 9C show EDS analysis for 10 cycles at 150 μm.

FIG. 10A and FIG. 10B show plots of higher current density tests for 2 mA cm⁻² in FIG. 10A and for 5 mA cm⁻² in FIG. 10B according to examples of the present disclosure.

FIG. 11 shows a plot of depth of discharge tests for planar, intermediate PZE, and large PZ7AE according to examples of the present disclosure.

FIG. 12 shows a plot of XRD analysis of pristine and cycled anodes according to examples of the present disclosure.

FIG. 13 shows a table comparing the ratio of zinc in the (002) plane to the (101) plane in pristine vs. cycle electrodes and a table comparing the Full Width Halve Mass (FWHM) according to examples of the present disclosure.

### DETAILED DESCRIPTION

According to examples of the present disclosure, a binder fabrication method is disclosed using different starting zinc particle sizes to determine optimal surface area, porosity, zinc-to-zinc oxide ratio to maximize cycle stability and mitigate dendrite growth. From the present findings, a porous zinc anode is produced that is made from large (150 μm) starting particles that are stable for 700 h without showing signs of failure. The large PZE also exhibits an increase in electrolyte stability, showing an increase of 300 h of plating and stripping before the electrolyte begins to degrade when compared to planar zinc. The bulk and interfacial resistance of the cell is also decreased when switching from the planar zinc to the porous zinc, resulting in a lower over potential to be required to strip and plate the zinc ions. These batteries utilize 2 M ZnSO₄+5% PEG 300 as it a common electrolyte used in zinc batteries and PEG additives have been shown to increase the performance of zinc batteries.

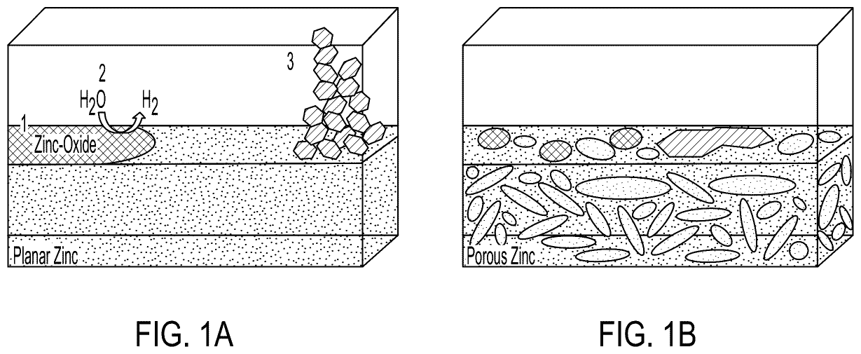

FIG. 1A and FIG. 1B show schematic diagram of plating patterns on a planar zinc and a porous zinc electrode, as well as failure mechanisms that plague metal anodes, according to examples of the present disclosure, where FIG. 1A shows a planar zinc and several failure mechanisms including: (1) an insulating layer of zinc oxide that passivates on the surface of the anode. (2) hydrogen evolution producing hydrogen gas and degrading the electrolyte and (3) dendrite formation, uneven plating causing tree like branches to form over repeated cycles until the separator is pieced and a bridge between the electrodes is formed causing the cell to short and FIG. 1B shows a dendrite plating structure on a porous zinc anode according to examples of the present disclosure.

### Materials & Methods

All materials were bought commercially and were not modified in any manner. 150 μm zinc (99%) was obtained from Sigma Aldrich. 10 μm zinc (99%) was obtained from Sigma Aldrich. 60 nm zinc (99%) was obtained from Sigma Aldrich. 0.1 mm thick planar zinc (99.9%) was obtained from MTI. Zinc sulfate anhydride (99.5%) was obtained from Sigma Aldrich. All coin cell pan were CR2032-C-304SS. 934-Ah glass microfiber separator were obtained from Cytiva. Polyethylene glycol 300 (PEG300) was obtained from Sigma Aldrich. Zinc oxide (99.9%) was obtained from Sigma Aldrich. Polytetrafluoroethylene (PTFE) was obtained from Sigma Aldrich. Sodium dodecylbenzenesulfonate (SDBS, technical grade) was obtained from Sigma Aldrich.

### Anode Fabrication

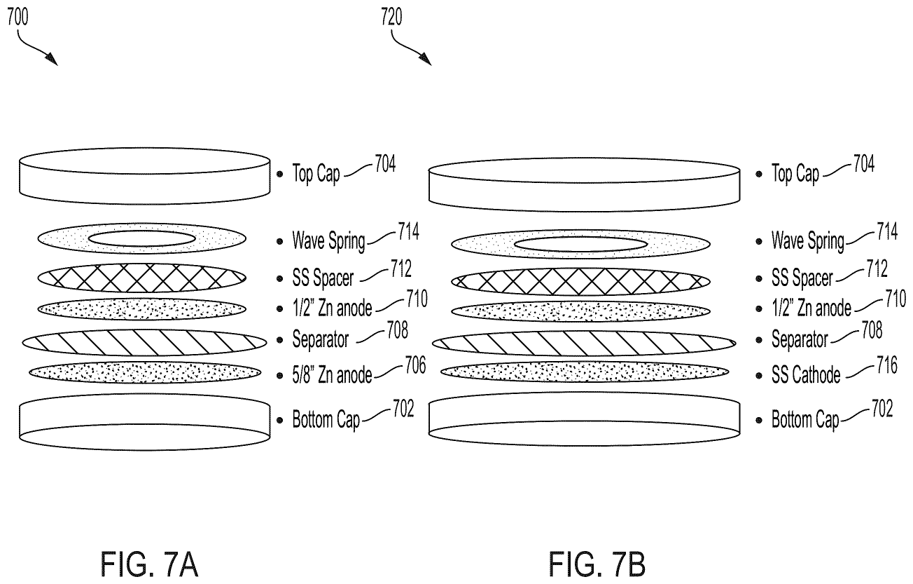

FIG. 7A and FIG. 7B show a coin cell configuration of Zn∥Zn cells 700 and Zn vs. stainless steel 720, respectively, according to examples of the present disclosure. The fabrication method used to make PZEs is as follows. To make the anode (⅝″ Zn anode 706), 83 wt % zinc, 9.8 wt % zinc oxide, 2.2 wt % SDBS, and 5 wt % PTFE were combined in a mortar and pestle and were thoroughly mixed to form a puddy by adding small amounts of isopropyl alcohol (IPA) as needed for 1 h. Next, the puddy was roller pressed until the puddy was flat and around 1 mm in thickness. The puddy was then cut into circles with ½ inch or ⅝-inch diameters as the PZE electrodes. The PZE were then put in the vacuum oven to be dried over night at a temperature of 60° C. and at a pressure of 650 mmHg. The dried PZEs were assembled into coin cells. PZEs were made using small (60 nm), intermediate (10 μm), and large (150 μm) starting zinc particle sizes. The ½ inch intermediate PZE had an average of 0.19113 g of active material and the large PZE of the same diameter had an average of 0.20775 g of active material. The ½ inch planar zinc weight an average of 0.10 g. Coin cell parts were washed in acetone and DI water prior to assembly. Symmetric Zn∥Zn coin cell were assembled by placing the larger PZE electrode into the bottom cap 702 followed by the separator 708. 100 μL of 2M ZnSO₄ with 5 wt % PEG300 electrolyte was then added to the separator 708. The smaller PZE electrode (½″ Zn anode 710) was placed on top followed by the spacer (stainless steel (SS) spacer 712) and wave spring 714. The top cap 704 was then placed on the top, and the cell was sealed using a battery crimper. Planar symmetric Zn∥Zn cell were made in a similar method using planar zinc that was cut into the same sizes as the PZEs. Zinc vs stainless steel cells were made by using a 304 SS disk (SS cathode 716) in place of the larger PZE. Visualization of cell assembly can be found in FIG. 7A and FIG. 7B.

### Electrochemical Characterization

Electrochemical impedance spectroscopy (EIS) and linear sweep voltammetry (LSV) were performed using a Biologic electrochemical potentiostat. EIS was conducted using a 5 mV AC amplitude from open circuit potential in a frequency range from 200 kHz to 100 mHz. LSV was conducted using a scan rate of 1 mVs⁻¹ in a range of −0.2 V to 5 V vs the reference electrode of zinc. Depth of discharge (DoD_{zn}) and galvanostatic stripping tests were performed using a Neware mass battery tester. Galvanostatic constant current tests were conducted using currents ranging from 1 mAcm⁻² to 5 mAcm⁻². Batteries were discharged and charged for one hour at a time with a minute rest in between for ten, twenty, one hundred cycles, or until failure using the various currents. DoD_{zn} tests were conducted by discharging zinc vs stainless steel electrode under a constant current of 1 mAcm⁻². Anodes were pre-weighed before assembly to determine the amount of active material inside of the PZEs.

### Material Characterization of Electrodes

Pristine anodes were fabricated and characterized before placing into a cell. Cycled cells were opened where anodes were washed with the ZnSO₄ electrolyte and then methanol to remove any residual electrolyte and separator pieces. The washed electrodes were then dried at 60° C. overnight in a vacuum oven at 600 mmHg. Scanning electron microscopy (SEM) was performed using a Tescan Vega 3 and energy dispersive spectroscopy (EDS) was performed using an IXRF Iridium Ultra with an SSD X-ray detector with an accelerator voltage of 20 kV at a working distance ranging from 0.17 mm to 0.22 mm. XRD was performed using a Rigaku SmartLab X-ray diffractometer. Brunauer-Emmett-Teller (BET) surface area analysis was performed using a Micromeritics Gemini 2360 Surface Area Analyzer using liquid nitrogen as the coolant.

### Results and Discussion

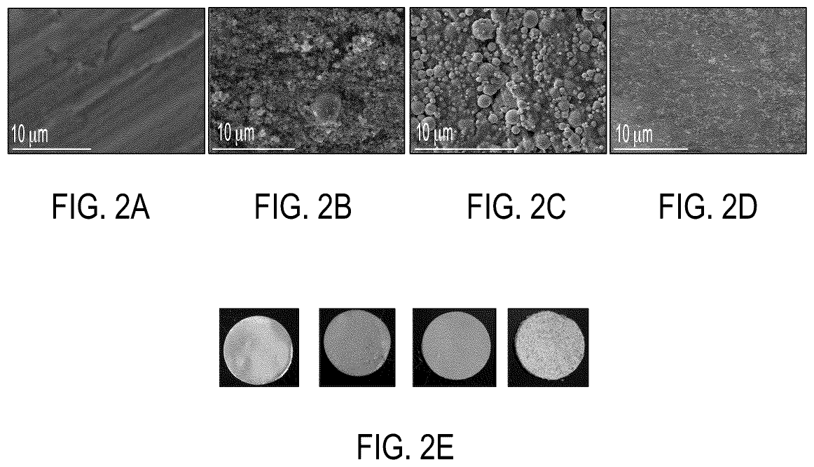

FIG. 2A, FIG. 2B, FIG. 2C, FIG. 2D, and FIG. 2E show SEM images or the pristine planar and porous zinc anodes made from different zinc particle sizes according to examples of the present disclosure, where planar zinc is shown in FIG. 2A, 60 nm is shown in FIG. 2B, 10 μm is shown in FIG. 2C, 150 μm is shown in FIG. 2D, and optical visualization of zinc anodes, from the left planer zinc, 60 nm, 10 μm, and 150 μm are shown in FIG. 2E.

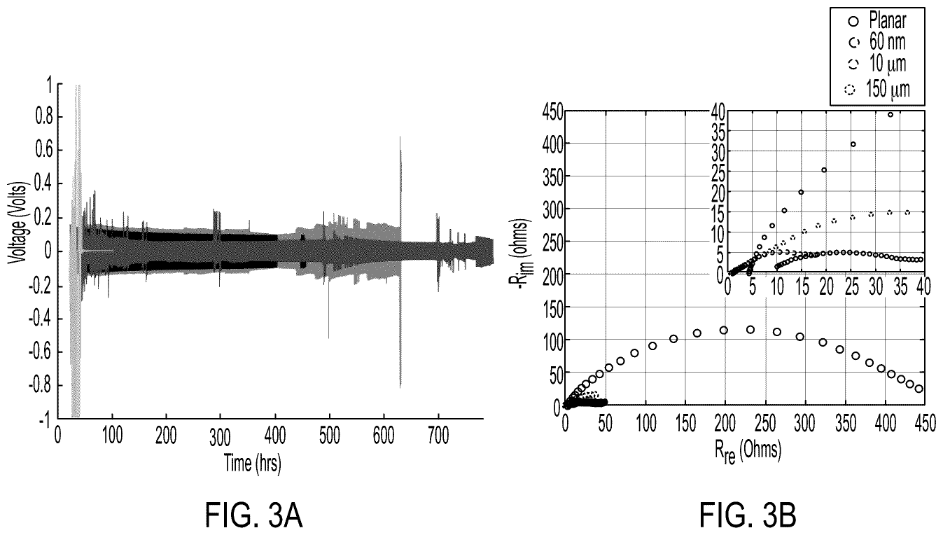

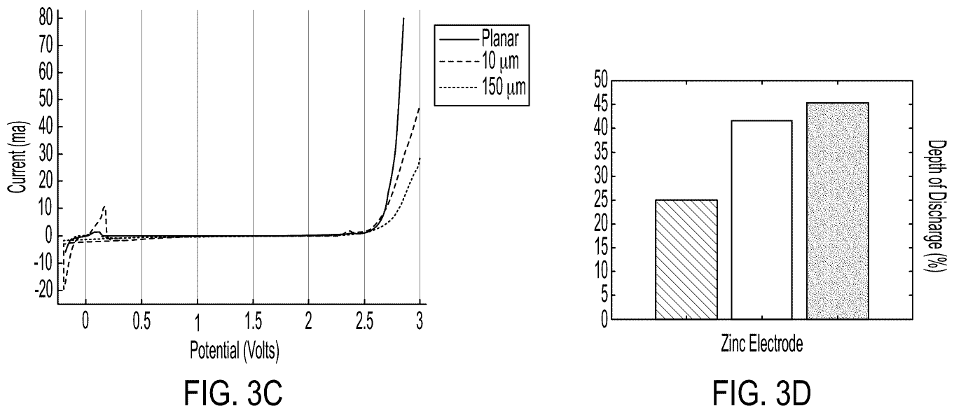

FIG. 3A, FIG. 3B, FIG. 3C, and FIG. 3D show electrochemical characterization of the PZEs fabricated from different starting particle sizes according to examples of the present disclosure, where FIG. 3A shows galvanostatic cycling of symmetric coin cells of various starting particle sizes and all tests occur under a current density of 1 mA cm⁻² and use an electrolyte of 2 M ZnSO₄+5 wt % PEG300, FIG. 3B shows a EJS Nyquist plot comparing the resistance of different porous anodes to planar zinc and the insect shows a zoomed in scale of FIG. 3B, FIG. 3C shows LVS curves comparing 150 μm PZE, 10 μm PZE and planar zinc at a scan rate of 1 mV s⁻¹, and FIG. 3D shows depth or di charge testing comparing 150 μm PZE, 10 μm PZE and planar zinc.

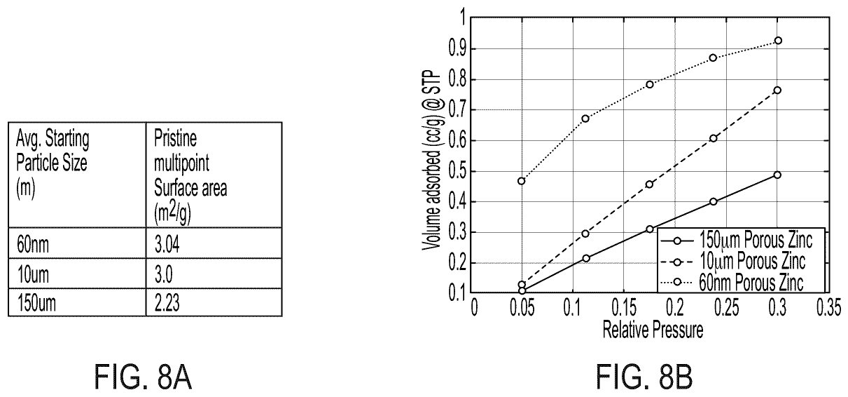

FIG. 8A and FIG. 8B show BET analysis results according to examples of the present disclosure.

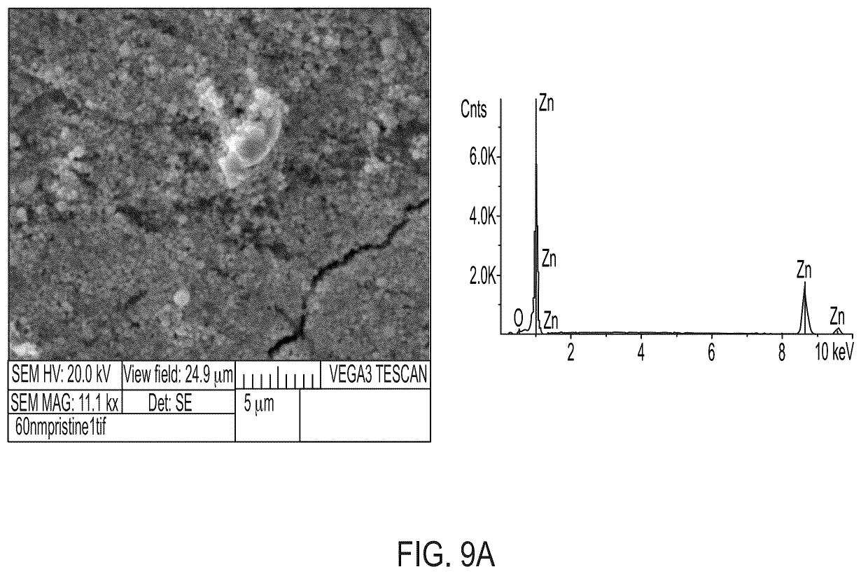

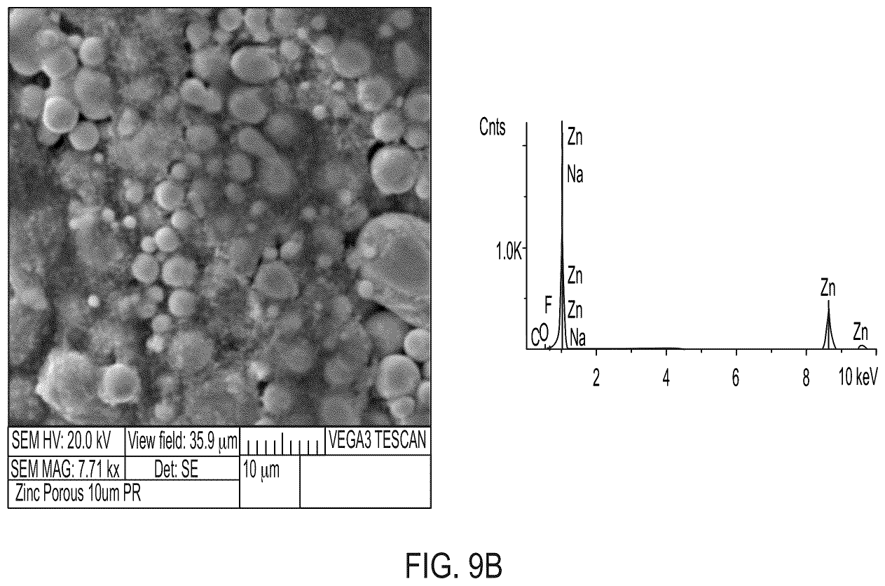

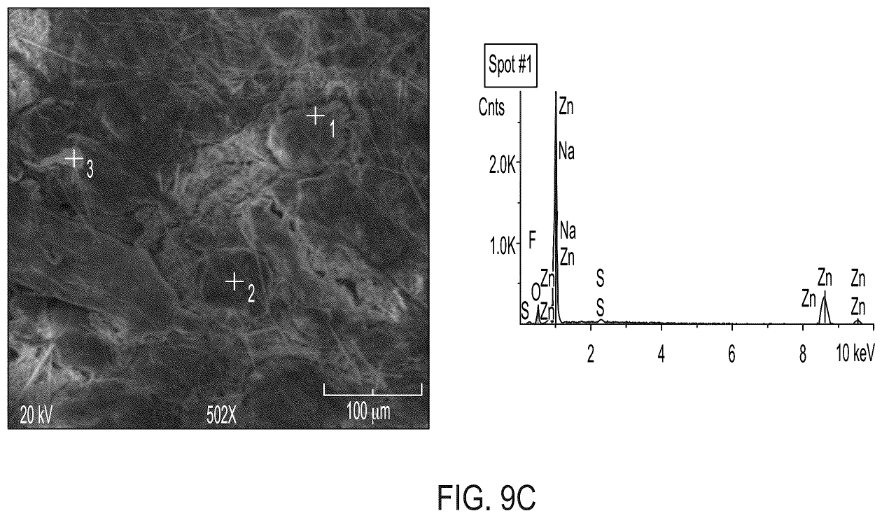

FIG. 9A, FIG. 9B, and FIG. 9C shows an EDS analysis of PZE, according to examples of the present disclosure, where FIG. 9A where FIG. 9A shows EDS analysis for pristine 60 nm, FIG. 9B shows EDS analysis for pristine 10 μm, and FIG. 9C show EDS analysis for 10 cycles at 150 μm.

Porous zinc anodes were fabricated and characterized under SEM to compare the surface morphology of the electrodes made from different starting zinc particle sizes. Visualization of the surfaces of the electrodes are used to determine the optimal morphology, porosity, and zinc-to-zinc oxide surface ratio. The electrode surfaces are characterized at both pristine state and at different stages of galvanostatic cycling conditions to study the morphology evolution under cycling conditions. The porosity and the surface area of the PZE need to be confirmed first before preforming any electrochemical characterization tests. BET analysis was done to confirm that the PZEs are porous and to determine their surface areas (FIG. 8A and FIG. 8B). The surface area of the large PZE is found to be 2.23 m²g⁻¹, while the intermediate PZE has a larger surface area of 3.0 m²g⁻¹. The small PZE has the largest surface area of the three at 3.04 m²g⁻¹. Optical visualization and SEM images of the pristine surface. of the planar zinc and the PZE can be seen in FIG. 2A, FIG. 2B, FIG. 2C, FIG. 2D, and FIG. 2E. It is clear that the surface of planar zinc is relatively flat and smooth with only a few minor defects. Furthermore, the crystal structure of the planar zinc oriented linearly. Individual particles cannot be seen on the surface, confirming that the zinc is planar. In contrast, the surface of the small PZE is rough with a large variety of different particles made of zinc and zinc oxide. More spherical particles that cover the surface of the small PZE are smaller compared to the intermediate and large PZEs EDS spot mapping (FIG. 9A, FIG. 9B, and FIG. 9C) of the mall PZE shows a larger amount of zinc oxide on the surface of the anode compared to the EDS maps of the intermediate and large PZEs. This is because larger surface area of the small PZE tends to be oxidized more easily compared to the intermediate and large PZEs, which causes a higher zinc oxide to zinc ratio on the surface. In FIG. 2C, the intermediate PZE surface can be seen. The surface is smoother than the small PZE and the individual particles are bigger. Larger pores are also now visible when compared with the small PZE. The surface of the large PZE can be seen in FIG. 2D. The surface of the large PZE is smoother than the other two PZE. We hypothesize that the smoothness of the of the surface contribute to the electrode stability to mitigate dendritic growth. The surface of the large PZE has fewer individual particles than the small and intermediate PZE. This is attributed to the larger different starting particle sizes of the materials during the mortar and pestle process. The intermediate PZE has the lowest difference in starting particle size with both the zinc and zinc oxide being 10 μm. The 60 nm nanoparticle zinc was too small to be crushed during the electrode fabrication process, so it has the largest number of individual particles. The 150 μm zinc panicles can be crushed easily during the process allowing for a smooth porous surface. An optical comparison of the different PZEs and planar zinc is shown in FIG. 2E. The mall and intermediate PZE have a smooth velvety surface, while the texture of the large PZE looks more similar to a sandpaper.

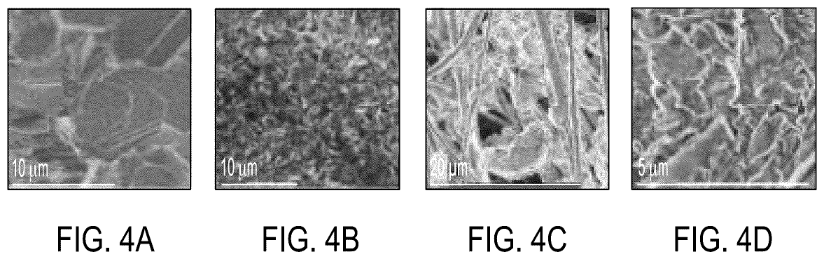

FIG. 4A, FIG. 4B, FIG. 4C, and FIG. 4D show SEM images of zinc electrodes made from different particle sizes, where symmetric coin cells in an electrolyte of 2 M ZnSO₄+5 wt % PEG300 are tested under a constant current of 1 mAcm⁻² until failure according to examples of the present disclosure, where a planar zinc is shown in FIG. 4A, 60 nm is shown in FIG. 4B, 10 μm is shown in FIG. 4C, and 150 μm is shown in FIG. 4D.

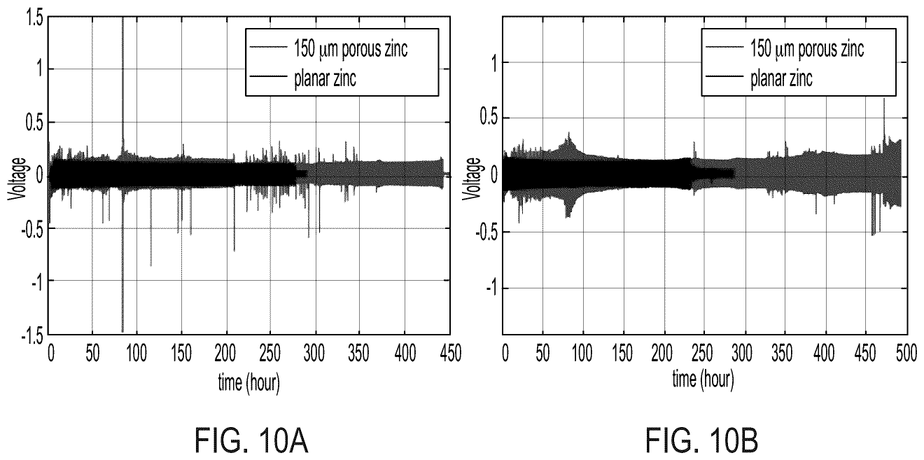

FIG. 10A and FIG. 10B show plots of higher current density tests for 2 mA cm⁻² in FIG. 10A and for 5 mA cm⁻² in FIG. 10B according to examples of the present disclosure.

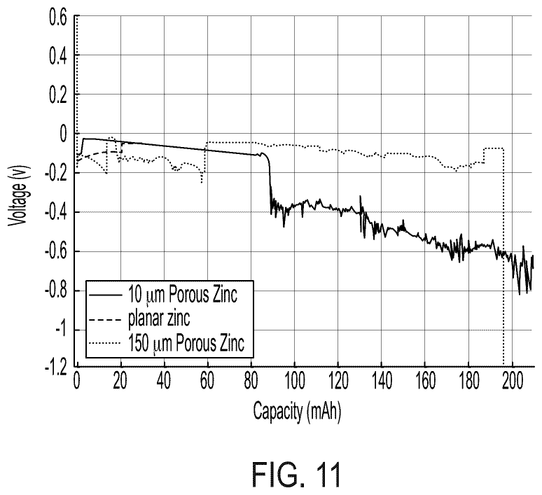

FIG. 11 shows a plot of depth of discharge tests for planar, intermediate PZE, and large PZE according to examples of the present disclosure.

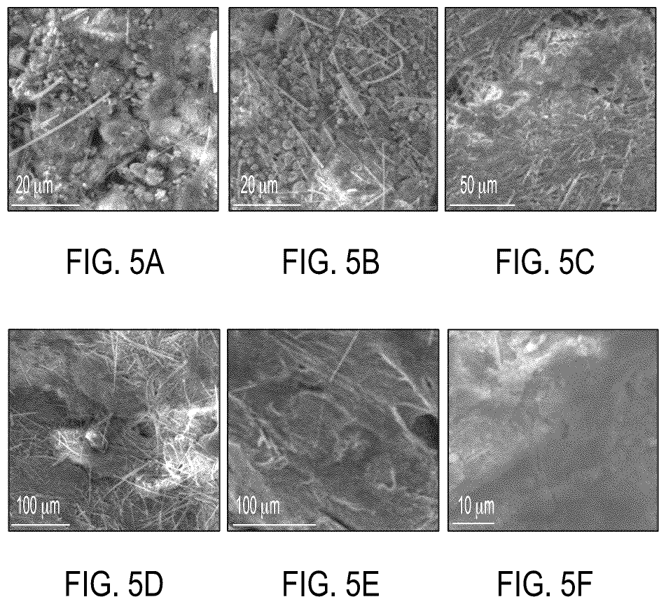

To evaluate the electrochemical performance of the PZEs towards energy storage applications, we tested each of the PZE using a variety of electrochemical condition and then compared the result to each other (FIG. 3A, FIG. 3B, FIG. 3C, and FIG. 3D). The galvanostatic cycling of symmetric cells of the PZEs at a current density of 1 mAcm⁻² are shown in FIG. 3A. increasing the starting zinc particle size is found to increase the cycle life of the zinc symmetric cells. Large PZE can be seen to have the longest cycle life among all PZEs, showing stable cycling for 700 h. Cells made from the intermediate PZE last for around 450 h before failing. Both the intermediate and large PZEs outperform the planar zinc anodes. The voltage plateaus of the intermediate PZE are higher than the voltage plateau of the large PZE. The galvanostatic cycling tests with higher current density of 2 mA cm⁻² and 5 mA cm⁻² were also performed and the results are shown in FIG. 10A and FIG. 10B. The large PZE fails around 450 h for both test while planar zinc fails at 275 h and 240 h respectively. The large PZE shows an increase into the voltage plateau as the applied current increases, while the planar zinc maintains the same plateau for all three currents applied. Small PZE performs very poorly and fail with in the first ten cycles of the battery and are very unstable with a larger voltage plateau range from −1 V to 1 V. The large voltage spikes on the charge and discharge cycles disappear once the dendrite pierces the separator and creates an internal short in the cell, causing the voltage to go to zero. The poor performance of the small PZE is attributed to the increased amount of zinc oxide on the surface of the anode. Zinc oxide increases the affinity of water splitting and insulates active material on the electrode. Since there is more zinc oxide on the surface of the electrode than zinc, the battery is more prone to large unstable voltage spikes and hydrogen evolution during the charge/discharge process. Further evidence of the increased amount of zinc oxide on the surface of the small PZE can be seen in the Nyquist plots in FIG. 3B. The interfacial resistance of the small PZE is larger than the interfacial resistance of the intermediate and large PZEs. The interfacial resistances of all three PZEs are much smaller than planar zinc, indicating less energy is required to strip and plate zinc ions on the PZEs. Due to the poor performance of the small PZE during initial testing, further electrochemical and characterization tests are focused on the intermediate and large PZE exclusively. In FIG. 3C. LSV result of the Zn∥stainless steel cell can be seen. It is clear that zinc stripping and platting on the stainless-steel electrodes are visible at −0.2 V & 0.2 V for all PZEs as well as the planar zinc. Electrolyte decomposition occurs around 2.7 V for the large PZE, while it occurs around a slightly lower voltage of 2.6 V for planar zinc and intermediate PZE. In FIG. 3D, DoD_{zn} result. are shown. Intermediate PZE has a DoD_{zn} of 41%, while the large PZE has a DoD_{zn} of 45%. DoD_{zn} of the planar zinc is found to be 25%. The lower resistance and energy requirement to strip zinc ions from the PZEs allow for a higher depth of discharge to be achieved in these electrodes. The voltage profile of the DoD_{zn} test can be found in Supporting information FIG. 5. The intermediate PZE has a capacity of 89 mAh while the large PZE has a capacity of 57 mAh. The planar zinc has a capacity of 21 mAh. The DoD_{zn} was found by multiplying the weight of each anode with the theoretical capacity of zinc. The batteries were then discharged until failure and then the actual capacity was compared to the theoretical capacity.

Previous research has reported that planar zinc electrode, during plating and stripping cycles, prefers to deposit in the (002) plane as a hexagonal close packed (HCP) crystal structure. The present results agree with these findings and can be seen in FIG. 4A, FIG. 4B, FIG. 4C, and FIG. 4D which show SEM image of different cycled zin electrodes. By viewing the cycled batteries, we can observe the changes to the surface morphology of the zinc in order to determine which features improve cycle stability. In FIG. 4A, HCP zinc crystal deposits can be seen on the surface of the planar zinc electrode. Compared to the smooth surface of planar zinc at the pristine state seen in FIG. 1A and FIG. 1B, over many cycles, the surface of the planar zinc is covered with plated zinc crystals. The crystal structure of the deposited zinc is HCP which is the preferred zinc morphology during electrodeposition. Due to the kinetic instability that occurs when currents above the diffusion limiting current are used during the plating and stripping cycles, these crystals do not plate parallel to the surface. Instead, the zinc HCP deposits stack unevenly on top of each other creating areas with higher local currents. This causes more uneven plating to occur and begins the dendritic cycle, which eventually results in internal shorted induced battery failure. FIG. 4B shows SEM images of a cycled small PZE after short circuit. The deposits on the small PZE are similar to the deposit found planar zinc with an HCP crystal structures. However, the deposits on the intermediate and large PZE indicates a shift from HCP crystal deposits to amorphous zinc metal deposits as the zinc particle size increases. Furthermore, the surface of the mall PZE is covered with these HCP crystals during the first few cycles of galvanostatic cycling as seen in FIG. 3A when the small PZE fails before reaching 10 cycles. This indicated that the small PZE is worse for the mitigation of dendrite compared to the intermediate and large PZEs. In FIG. 4C, SEM images of cycled intermediate PZE show an increased affinity to deposit in the separator compared to the rest of the PZE and planar zinc. The intermediate zinc has the highest affinity to deposit on the glass microfiber separator, which we believe is caused by the similar size of the zinc relative to the pores of the glass microfiber separator used. Previous studies show similar effect on the planar zinc electrode that zinc tends to deposit the glass microfiber due to its ability to regulate ion transport behavior. While the glass fiber smooths the zinc deposition of the intermediate PZE, the zinc deposited in the separator decreases the amount of active zinc material inside the electrode, therefore, decreasing the performance of the cell over continuous cycling. In FIG. 4D, SEM images of large PZE show uniform and smooth plating compared to the HCP crystal seen on planar and small PZE. The zinc deposits on the surface of the large PZE are amorphous zinc metal. It is believed that these amorphous deposits are the main reason for the increased stability and overall performance of the cell.

FIG. 5A, FIG. 5B, FIG. 5C, FIG. 5D, and FIG. 5E show intermediate and large PZE from various cycles to view surface changes over time according to examples of the present disclosure, where the top row is intermediate PZE at 10 cycle shown in FIG. 5A, 20 cycles shown in FIG. 5B, 100 cycles shown in FIG. 5C and the bottom row is large PZE at 10 cycle shown in FIG. 5D, 20 cycles shown in FIG. 5E, and 100 cycles shown in FIG. 5F.

To evaluate the morphological evolution of the intermediate and large PZEs at various cycles, the SEM images of intermediate and large PZEs were examined to see how the surface changed over time and the results can be found in FIG. 5A, FIG. 5B, FIG. 5C, FIG. 5D, and FIG. 5E. SEM images of intermediate PZE at 10, 20, and 100 cycles respectively can be seen in FIG. 5A, FIG. 5B, and FIG. 5C. Very little changes can be observed from the pristine surface of the intermediate PZE compared to the surface at 10 cycle. After 20 cycles, mall deposits of amorphous zinc can be seen. After cycling the intermediate PZE for 100 cycles, the surface has changed from the rough, bumpy surface to a smoother surface covered by zinc deposits. Large zinc deposits bound to the glass fiber separator can also be seen. FIG. 5D, FIG. 5E, FIG. 5F show SEM images of large PZE at 10, 20, and 100 cycle respectively. Similarly, to the intermediate PZE, not many changes in morphology can be found on the surface of the large PZE after 10 cycles. After 20 cycles, the surface is still similar to the pristine surface of the large PZE. After 100 cycles, amorphous zinc deposit can be seen on the surface, while most of the amorphous zinc are deposited on the large PZE electrode surface instead of on the glass fiber separator.

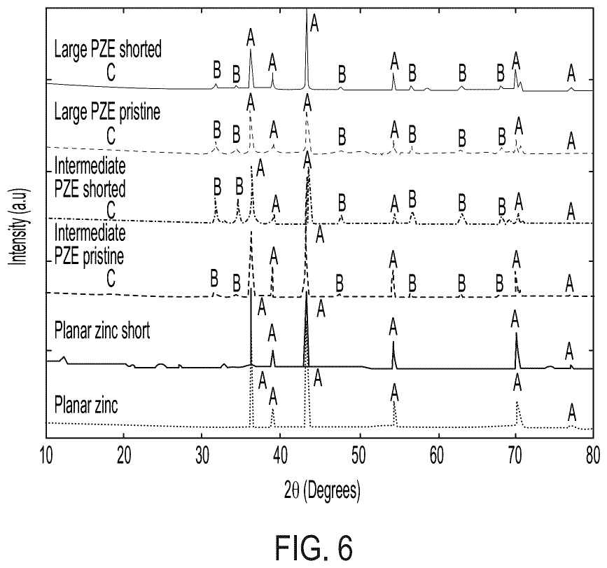

FIG. 6 shows XRD analysis of pristine and cycled anodes according to examples of the present disclosure, where peaks for zinc (98-000-0482) is shown by A, peaks for zinc oxide (98-000-0483) is shown by B, and peaks for PTFE (00-047-22 17) is shown by C.

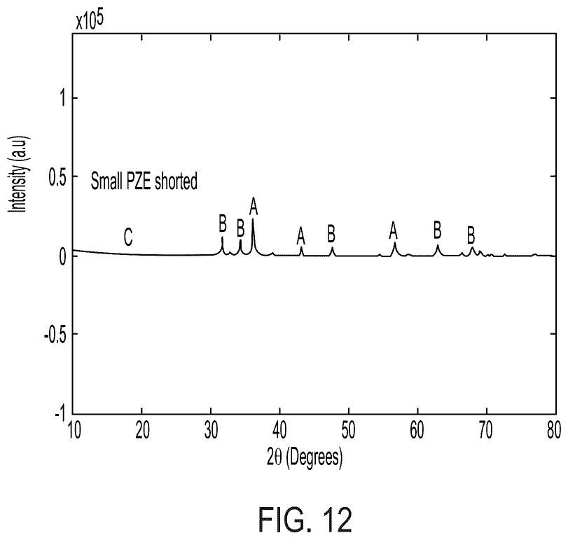

FIG. 12 shows a plot of XRD analysis of pristine and cycled anodes according to examples of the present disclosure.

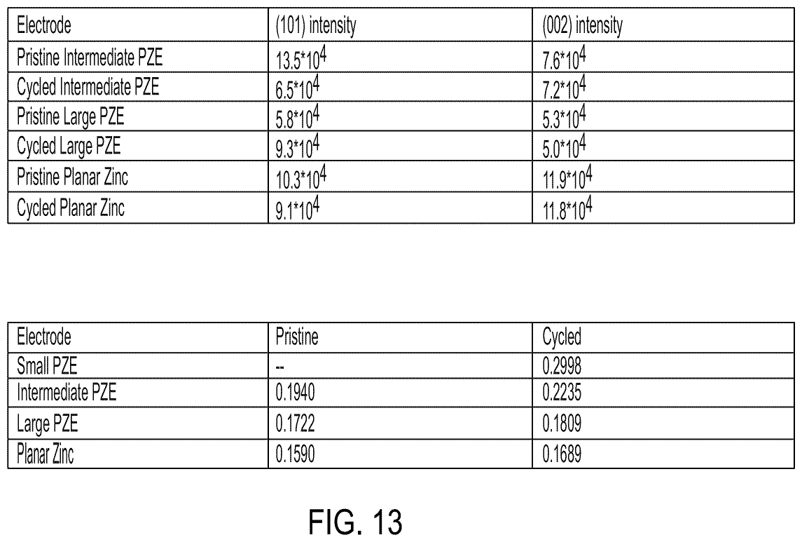

FIG. 13 shows a table comparing the ratio of zinc in the (002) plane to the (101) plane in pristine vs. cycle electrodes and a table comparing the Full Width Halve Mass (FWHM) according to examples of the present disclosure.

To confirm the crystal structure of the deposited zinc at different electrode surface, an XRD analysis was performed on planar zinc, intermediate and large PZE. There results are shown in FIG. 6. The XRD patterns of the PZE are similar regardless of the starting particle size. From the XRD analysis of the intermediate PZE, it is confirmed that the deposit structure changes from HCP crystals to amorphous zinc as the size of the zinc particles increase from the nanoscale to the microscale. XRD results of the small PZE are shown in FIG. 12. Full width half mass (FWHM) values can be found in Table II as shown in FIG. 13, which follow the correlation between microparticle size and FWHM described by the Scherrer equation. Furthermore, the cycled intermediate PZE had a zinc-to-zinc oxide ratio of almost 3 to 1 while the pristine intermediate PZE had a ratio of nearly 4 to 1. The pristine large PZE had a starting zinc-to-zinc oxide ratio of nearly 2 to 1. After cycling the. large PZE until failure, the zinc-to-zinc oxide ratio became 3 to 2. This suggests that the zinc oxide passivation layer evolves differently in the intermediate and large PZE. The different ratios of zinc-to-zinc oxide in the pristine anodes are believed to be caused by the intermediate zinc particles being the same size as the ZnO particles while the large zinc particles are much larger. The higher zin-to-zinc oxide ratio of the intermediate PZE compared to the large PZE might explain the larger voltage plateau that can be seen in FIG. 3A. The higher zinc-to-zinc oxide ratio leads to more surface passivation during the cycling causing the voltage to increase until the voltage reached the safety limit set on the tester. The shorted planar zinc anode did not show the same zinc oxide peaks as the intermediate and large PZEs. It is believed this is due to zinc oxide depositing as an amorphous structure or the crystal size being too small to be detected by the XRD instrument. Zinc oxide peaks can be seen on both the intermediate and large PZE. The peak intensity of the ZnO decreases from the pristine large PZE to the cycled one indicating that it gets reduced to zinc during cycling. The opposite effect is seen on the intermediate PZE where the peak intensity of ZnO increases from the pristine anode to the shorted one. This agrees with our failure mechanism during galvanostatic cycling that the zinc oxide increases the resistance of the cell until its eventual failure. The failure is also accredited to the loss of active material being deposited onto the glass microfibers instead of the counter electrode, which can be seen in the SEM images of the intermediate PZE is as little as 10 cycles. The large PZE anode shows a decrease in peak intensity at 36° which corresponds to the (002) HCP crystal structure. This agrees with prior findings by the inventors that zinc does not depos it as HCP crystals, but as amorphous zinc on the large PZE. Furthermore, the intensity of the (002) peak is much higher in the planar zinc than in either the intermediate or large PZE. The peak corresponding to the (101) crystal structure at 43° increases in intensity in both PZEs and the planar zinc sample. It is believed this is caused by the uneven dendritic growth during the galvanostatic plating and stripping cycle. When comparing the intensities of the (002) and (101) peaks between the pristine and cycled anodes (Table I as shown in FIG. 13), it was found that the ratio between the two peak decreases for the large PZE while it increases for the intimidate PZE. The ratio of the (002) peak to the (101) peak in the planar zinc does not change very much. The peak at 180 is found to be PTFE. The peak intensity was consistent in the pristine and cycled anodes.

### CONCLUSIONS

In summary, PZE made from large zinc particles has been shown to outperform PZEs made from small and intermediate particle sizes. Larger PZE are better suited to limit dendrite growth due to their ability to promote even plating. SEM and XRD of the cycled PZEs show that zinc deposits as amorphous instead of the HCP structure seen in planar zinc. The increased surface area of the anode also lowers the local diffusion limiting current, allowing for over 700 h of striping and plating at a current of 1 mAcm⁻². However, the lifespan of the planar zinc span is less than half of the total life span of the large PZE. The incorporation of zinc oxide throughout the electrode is found to mitigate the formation of a passivation layer on the surface of the anode and improve electrolyte stability in the large PZE as well. The electrolyte in the planar zinc cell started to decompose at 2.6 V while it decomposes at 2.7 V in the large PZE cell. Large PZE electrodes show promise as a potential anode candidate for zinc-air batteries. In some examples, one way to further improve these PZEs is to allow the addition of dopants inside the starting zinc particle.

The examples set forth herein represent the necessary information to enable those skilled in the art to practice the embodiments and illustrate the best mode of practicing the embodiments. Upon reading the description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A battery comprising:
an anode, the anode comprising a metal having a porous 3D structure; and
a cathode.

2. The battery of claim 1, wherein the metal is zinc.

3. The battery of claim 1, wherein the metal is coated on a surface of the anode.

4. The battery of claim 1, further comprising a bottom cap configured and sized to hold the anode.

5. The battery of claim 1, further comprising a separator layer arranged above the anode.

6. The battery of claim 5, further comprising an anode arranged above the separator layer arranged.

7. The battery of claim 6, wherein the anode comprises zinc.

8. The battery of claim 6, further comprising a spacer layer arranged above the anode.

9. The battery of claim 8, wherein the spacer comprises stainless steel.

10. The battery of claim 8, further comprising a spring arranged above the spacer layer.

11. The battery of claim 10, further comprising a top cap arranged above the spring and configured to engage with the bottom cap to produce a sealed battery case.

12. A method of fabricating a zinc anode, the method comprising:
combining 83 wt % zinc, 9.8 wt % zinc oxide, 2.2 wt % sodium dodecylbenzenesulfonate (SDBS), and 5 wt % polytetrafluoroethylene (PTFE);
adding an amount of isopropyl alcohol (IPA) for about one hour to produce a combined puddy product;
pressing the combined puddy product until flat and around 1 mm in thickness;
cutting the combined puddy product that is pressed into circles with W′ or ⅝″ diameters to produce cut Porous Zinc electrodes (PZEs);
during the cutting of PZE in a vacuum oven to be dried over night at a temperature of about 60° C. and at a pressure of 650 mmHg to produce dried PZE; and
assembling the dried PZE into coin cells.

13. The method of claim 12, further comprising prior to the assemble the dried PZE, wash the dried PZE in acetone and de-ionized water.

14. A method of assembling a battery comprising:
placing a first zinc electrode into a bottom cap;
placing a separator on top of the first zinc electrode;
adding 2M ZnSO₄ with 5 wt % polyethylene glycol 300 to the separator;
placing a second zinc electrode on top of the separator, wherein the second zinc electrode is smaller than the first zinc electrode;
placing a spacer on top of the second zinc electrode;
placing a wave spring on top of the spacer; and
placing a top cap on top of the wave spring.
